(19) United States
(12) Patent Application Publication
(10) Pub. No.: US 2026/0228115 A1
(43) Pub. Date: Aug. 6, 2026

(54) SCREEN INTERFACE TEST SYSTEM AND SCREEN INTERFACE TEST METHOD

(71) Applicant: Hitachi, Ltd., Tokyo (JP)

(72) Inventor: Kenji MIYASHITA, Tokyo (JP)

(73) Assignee: Hitachi, Ltd., Tokyo (JP)

(21) Appl. No.: 19/303,510

(22) Filed: Aug. 19, 2025

(30) Foreign Application Priority Data
Jan. 31, 2025 (JP) 2025-015715

(51) Int. Cl. G06F 11/3668; G06F 11/3698

(52) U.S. Cl. CPC G06F 11/3684; G06F 11/3698

(57) ABSTRACT

A screen interface test system comprising, an input part obtains image information of the screen to be tested, test contents and the number of operations, an operation decision section creates a prompt that requests the creation of operation contents to be performed in the test based on the received image information and test contents, and receives the operation contents from a generative AI using the created prompt, a script creation section creates a prompt requesting the creation of a script to perform the test based on the operation content received from the generative AI and the image information, and receives the script from the generative AI using the created prompt, an output section that outputs test results when the number of times the script received from the generative AI has been executed reaches the number of operations.

### TECHNICAL FIELD

This invention relates to a screen interface test system and a screen interface test method.

### BACKGROUND ART

The following test support devices are disclosed in Patent Document 1.

The GUI pre-operation screen image generator and the GUI post-operation screen image generator generate an image file (GUI pre-operation screen image) and an image file (GUI post-operation screen image) from a predetermined time before a user interface operation (hereinafter referred to as “operation”) to the time operation is detected, and detection image analysis section identifies the surrounding image file in which the operation was performed by comparing the pixel values of the screen image before and after GUI operation, and generate a test script with the position coordinates and operation information regarding the operations for which the surrounding image file corresponds to the screen of the application under test.

### Citation List

### Patent Document

[Patent documents1] Japanese unexamined patent publication Tokkai2012-103786

### SUMMARY OF THE INVENTION

### Problems to be Solved by the Invention

The test support device disclosed in Patent Document 1 discloses automatic creation of scripts for testing, but a person must determine what tests need to be performed.

In other words, the system records human operations on the screen, obtains operation information based on the recorded data, and generates test scripts based on the operation information.

Thus, the type of test to be performed depends on what operations a person has performed on the screen.

This makes it time-consuming to perform the necessary tests for a program with a screen interface.

### Solutions to Problems

The above problem is solved from a screen interface test system comprising, an input part obtains image information of the screen to be tested, test contents and the number of operations,

- an operation decision section creates a prompt that requests the creation of operation contents to be performed in the test based on the received image information and test contents, and receives the operation contents from a generative AI using the created prompt, a script creation section creates a prompt requesting the creation of a script to perform the test based on the operation content received from the generative AI and the image information, and receives the script from the generative AI using the created prompt, an output section that outputs test results when the number of times the script received from the generative AI has been executed reaches the number of operations.

### Effects of the Invention

The invention allows the necessary tests to be performed on programs with a screen interface.

### BRIEF DESCRIPTION OF THE DRAWINGS

FIG. 1 This is an example of a system configuration diagram of the screen interface test system in the embodiment.

FIG. 2 This is an example of an operation history table in the embodiment.

FIG. 3 This is an example of a test result table in the embodiment.

FIG. 4 This is an example of an image table in the embodiment.

FIG. 5 This is an example of an input JSON file when requesting a test to the screen interface test system in the embodiment.

FIG. 6 This is an example of a prompt output to the generative AI by the operation decision section in the embodiment.

FIG. 7 This is an example of an input file attached to the prompt when requesting the generation of operation contents in the embodiment.

FIG. 8 This is an example of a response from the generative AI to the operation decision section in the embodiment.

FIG. 9 This is an example of a prompt output by the positional coordinate acquisition section to the generative AI in the embodiment.

FIG. 10 This is an example of the first response from the generative AI to the positional coordinate acquisition section in the embodiment.

FIG. 11 This is an example of an input file attached to the prompt for grid number in the embodiment.

FIG. 12 This is an example of a second response from the generative AI to the positional coordinate acquisition section in the embodiment.

FIG. 13 This is an example of an image to obtain grid in the embodiment.

FIG. 14 This is an example of a grid image with grid information in the embodiment.

FIG. 15 This is an example of an image to obtain the grid after trimming in the embodiment.

FIG. 16 This is an example of an image after trimming with grid information in the embodiment.

FIG. 17 This is an example of a prompt output by the script creation section to the generative AI in the embodiment.

FIG. 18 This is an example of an input file attached to the prompt for script creation in the embodiment.

FIG. 19 This is an example of a response from the generative AI to the script creation section in the embodiment.

FIG. 20 This is an example of a flowchart showing the processing of the entire system in the embodiment.

FIG. 21 This is an example of a flowchart showing the processing of the operation decision section in the embodiment.

FIG. 22 This is an example of a flowchart showing the processing of the positional coordinate acquisition section in the embodiment.

FIG. 23 This is an example of a flowchart showing the processing of the script creation section in the embodiment.

### MODE FOR CARRYING OUT THE INVENTION

The embodiments are described with reference to the drawings. The embodiments described below do not limit the invention of the claims, and not all of the components and combinations thereof described in the embodiments are essential to the solution of the invention.

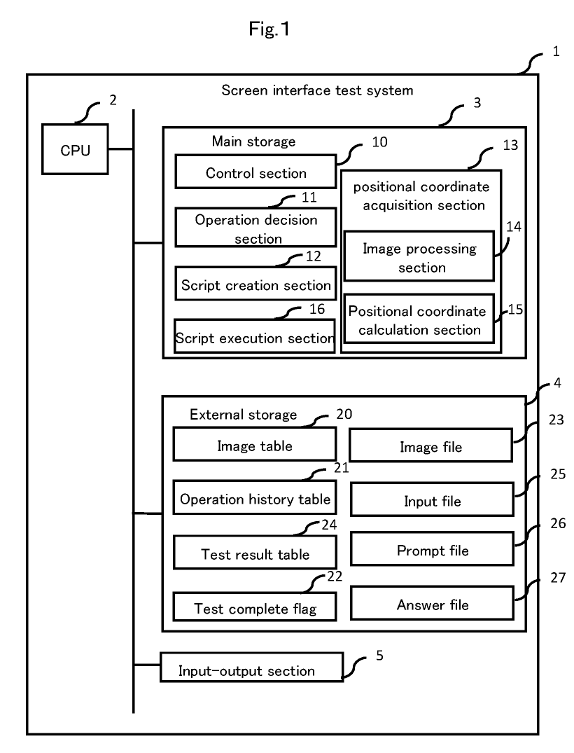

FIG. 1 is an example of a system configuration diagram of the screen interface test system in the embodiment.

The screen interface test system1 is implemented by a computer with CPU(Central Processing Unit) 2 that executes the processing modules of screen interface test system 1, main storage 3 including ROM(Read Only Memory), RAM(Random Access Memory) etc. storing various processing programs to process the feature of the screen interface test system1, external storage4 including HDD(Hard Disk Drive), SSD(Solid State Drive), and input-output section 5 including keyboard, mouse, touch panel, NIC(Network Interface Card) etc.

The functions of the screen interface test system 1 are realized by CPU 2 executing various processing programs stored in main storage 3 with reference to data stored in external storage 4.

Some or all of these programs may be introduced from other devices via non-transient storage media or communication lines or may be stored in advance. The embodiment described here is realized using a stand-alone computer, but it may also be realized by a cloud service that provides computing resources.

The main storage 3 storing a control section 10 that controls the entire screen interface test system, an operation decision section 11 that creates the content of the operation to be tested using a generative AI, script creation section 12 that creates a script to test the content of the operation using a generative AI, script execution section16 that cuts out the scripts generated by the generative AI and executes them in the browser using tools such as Selenium and, positional coordinate acquisition section 13 that acquire the positional coordinates of the target object for script creation.

In addition, positional coordinate acquisition section 13 is equipped with image processing section 14 that adds grid information to the image including the operation target and positional coordinate calculation section 15 to calculate the positional coordinates.

External storage 4 contains an image table 20 that stores a list of images, an image file 23 that stores screenshot images of the screen output by the program under test, an operation history table 21 that stores the results of executing the script created by the script creation section 12 test result table 24 that stores the test results obtained by executing the script, and test complete flag 22 that indicates whether the test is complete or not.

It also has a prompt file 26 that stores prompts created when operation decision section 11, positional coordinate acquisition section 13, and script creation section 12 request processing to the generative AI, an input file 25 that stores information used in prompts, and an answer file 27 that stores answers obtained from the generative AI.

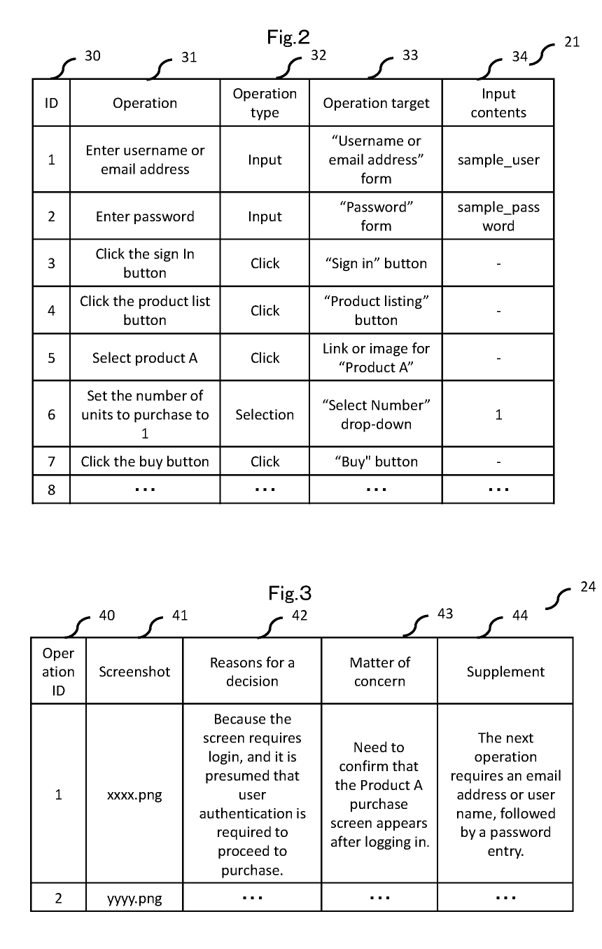

FIG. 2 shows an example of an operation history table in the embodiment. Where ID 30, operation content 31, operation type 32 such as input, click, selection, etc., operation target 33, and input content 34 when operation type 32 is input are stored correspondingly.

The latest operation is stored at the bottom of the operation history table 21 and the generative AI determines if the test is complete based on this information.

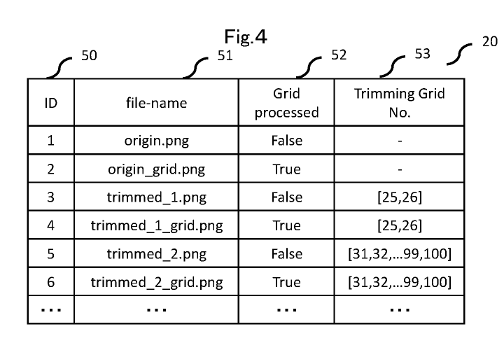

FIG. 3 is an example of a test result table in the embodiment. Operation ID 40, screenshot 41, reasons for judging test result 42, concerns about test result 43, and supplement 44 are stored correspondingly.

FIG. 4 is an example of an image table in the embodiment. ID 50, file name of the image 51, grid processed column 52, where False indicates that the grid processing has not been processed and True indicates that the grid processing has been processed, and trimmed grid number 53 is stored correspondingly.

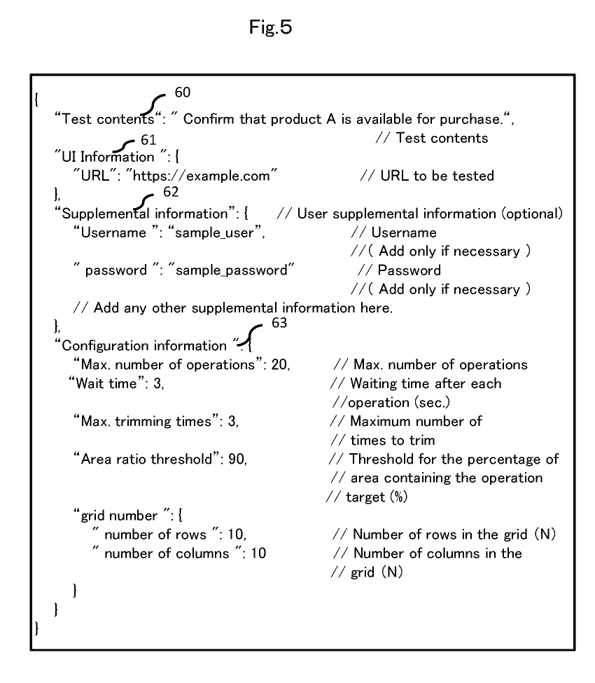

FIG. 5 is an example of an input JSON file when requesting a test to the screen interface test system in the embodiment. Test contents 60 contain the contents of the test that the user wants to check. UI information 61 contains the URL of the test target. Supplemental information 62 includes username, password, etc. in the case of a login screen test.

Configuration information 63 includes the maximum number of operations for the test, the wait time after each operation, the maximum number of times to trim the maximum number of times to execute trim, the threshold for the area percentage, which is the threshold (%) for the area percentage that contains the operation target, the number of rows in the grid, the number of columns in the grid, etc.

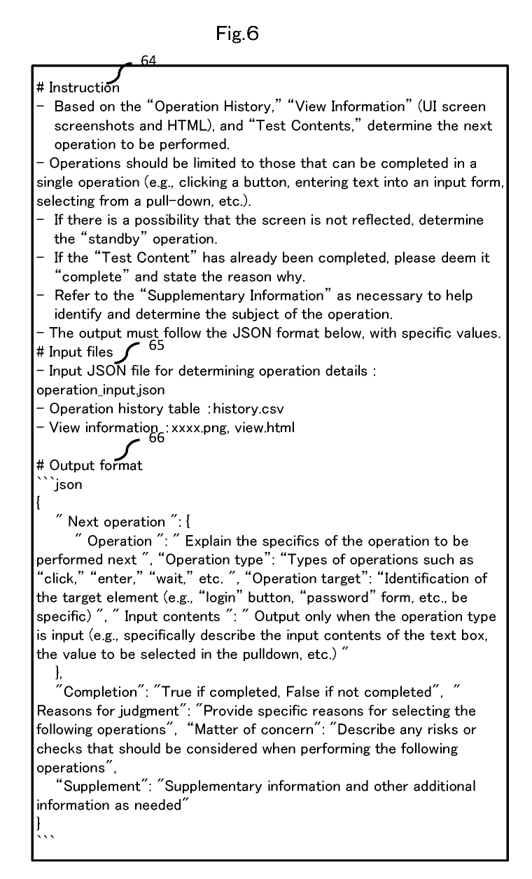

FIG. 6 is an example of a prompt output by the operation decision section in the embodiment to the generative AI. Instruction 64 is instructed to determine the operation and whether the test is complete.

Input file 65 specifies a file containing the input for the operation decision in JSON format, an operation history table containing the operation details, and view information, which is a screenshot of the screen where the operation target is displayed.

Output format 66 requires the next operation to be output in JSON format, which describes the operation content, operation type, operation target, and input content.

It also requires that True be output if the test is complete, False if not complete, and the reason for the decision to perform the next operation, concerns and supplements be output.

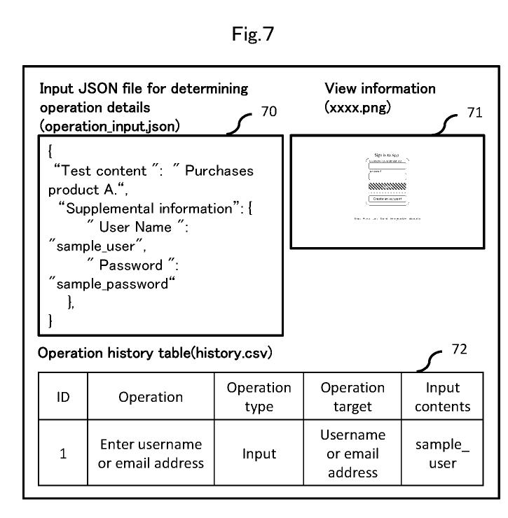

FIG. 7 is an example of an input file attached to the prompt when requesting the generation of operation contents in the embodiment. It includes the input JSON file 70 for determining the operation, view information 71, and operation history table 72. Since this example is an input file for the second operation decision, the operation history table 72 contains the operation performed the first time.

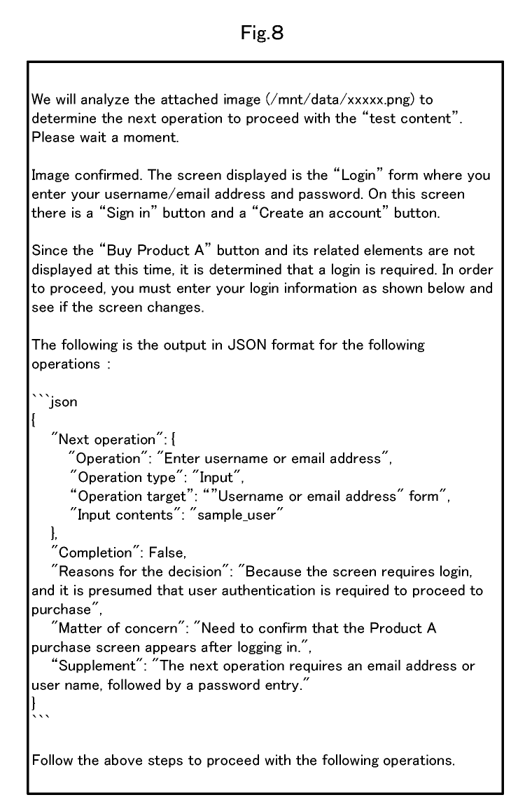

FIG. 8 shows an example of a response from a generative AI to the operation decision section in the embodiment. The content of the operation to enter a username or e-mail address is described in JSON format, and the test is not completed because the completion is False, with the reason that "login is required on the screen, and we assume that user authentication is required to proceed to purchase.".

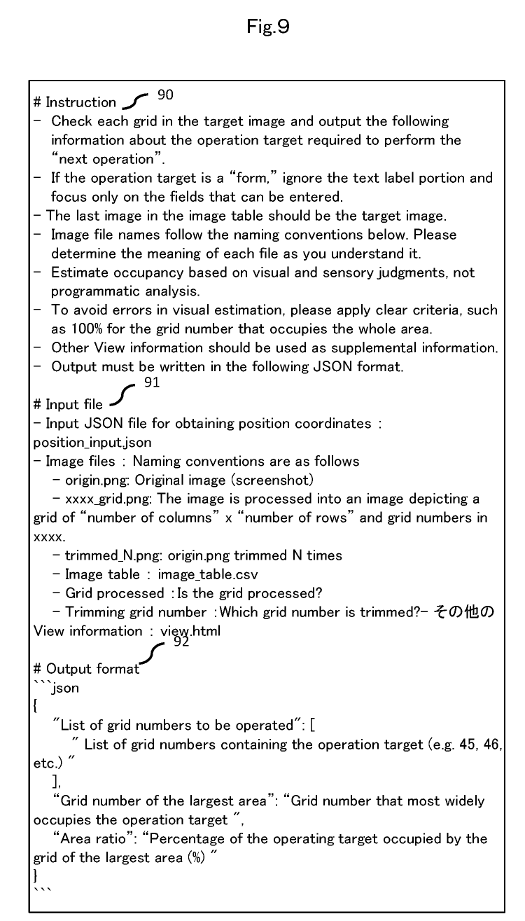

FIG. 9 shows an example of a prompt output by the positional coordinate acquisition section in the embodiment to the generative AI. In instruction 90, it is instructed to identify the target of operation using grid numbers.

In input file 91, an input JSON file for positional coordinate acquisition, a target image file, an image file to which grid information has been added, a trimmed image file, an image table with information indicating whether grid information has been added and at which grid number the image has been trimmed, and other View information.

Output format 92 instructs to output a list of grid numbers to be operated on, the grid number of the largest area, and the area percentage in JSON format.

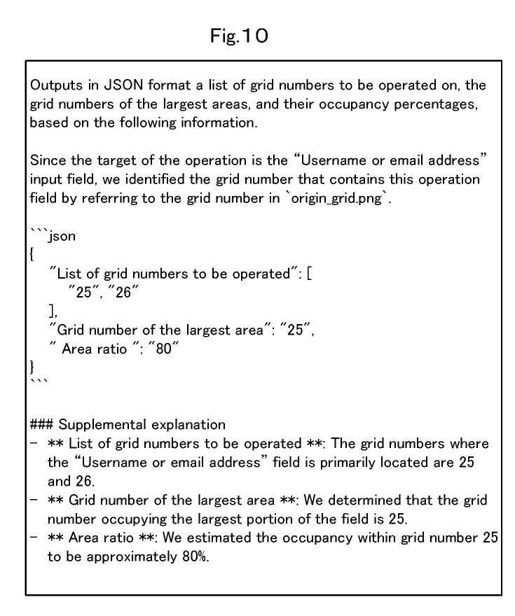

FIG. 10 shows an example of the first response from the generative AI to the positional coordinate acquisition section in the embodiment. The grid numbers of the operation target are 25 and 26, the grid number of the largest region is 25, and the area ratio of the operation target occupying the region with grid number 25 is 80%. If there is more than one largest region, one of them is selected by the generative AI.

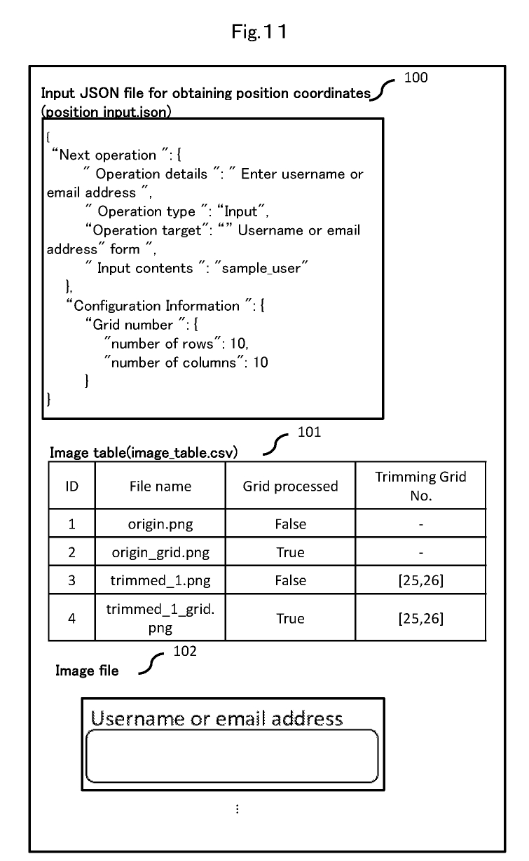

FIG. 11 is an example of an input file attached to the prompt for obtaining grid numbers in the embodiment. It contains an input JSON file 100 for obtaining position coordinates, an image table 101 and an image file 102.

The input JSON file 100 for obtaining position coordinates specifies the operation content, operation type, operation target, input content, and configuration information. In the configuration information, the number of grids is specified by the number of rows and columns. Image table 101 is a list of image files to be attached. The file name, grid processing or not, and trimming grid number are described.

In image file 102, all image files including images used in previous processes are attached. FIG. 11 shows the input file attached in the second process. In the first case, only the ID1 and ID2 items in the image table 101 are described, and the image file 102 corresponding to ID1 and ID2 are attached.

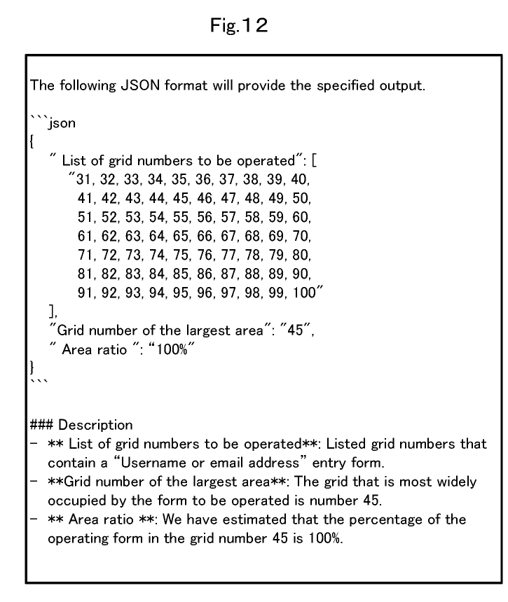

FIG. 12 shows an example of the second response to the positional coordinate acquisition section from the generative AI in the embodiment. The grid numbers to be manipulated are 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97,98, 99, 100, and the grid number of the largest region is 45 and the area ratio is 100%. If there is more than one grid number for the largest region, one is selected by the generative AI.

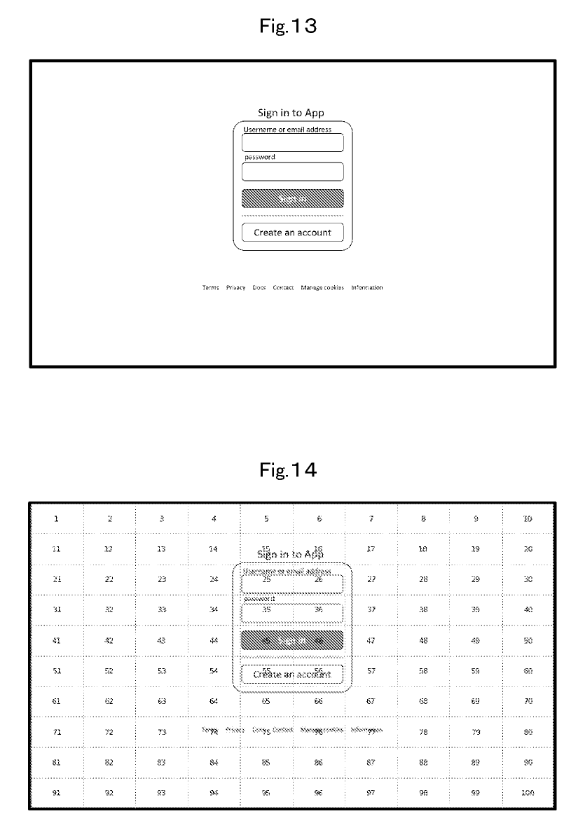

FIG. 13 shows an example of an image for determining the grid in the implementation, and FIG. 14 shows an example of an image with grid information added.

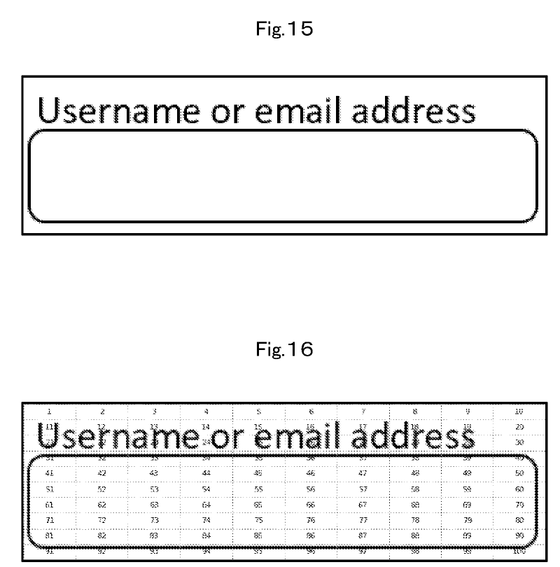

FIG. 15 is an example of an image for obtaining grid after trimming in the embodiment. Operation target is trimmed from the image of FIG. 13 to create a new image, and the operation target is enlarged and displayed. Specifically, the smallest rectangle that contains the grid number including the manipulated object is trimmed as the area.

An example of a trimmed image with grid information added is shown on FIG. 16. This image enables more accurate recognition of the target of the operation.

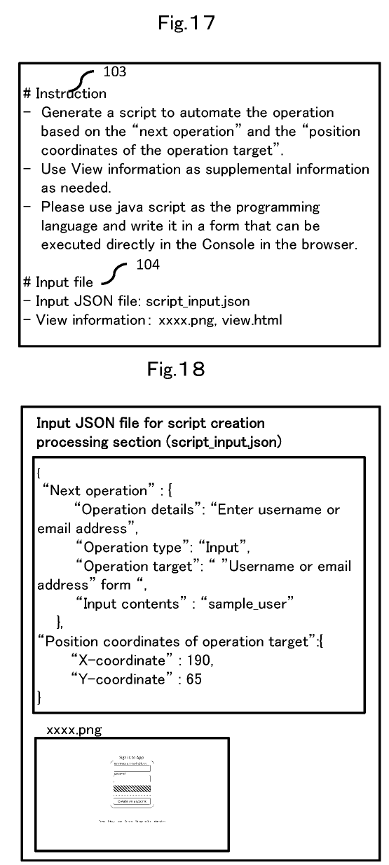

FIG. 17 is an example of a prompt output to a generative AI by the script creation section in the embodiment. Instruction 103 specifies to create a script to perform an operation using JavaScript. Input file 104 specifies an input JSON file and view information.

FIG. 18 shows an example of an input file attached to a prompt requesting script creation in the embodiment. It contains an input JSON file for a script creation section and view information. The input JSON file for the script creation section specifies the operation content, operation type, operation target, input content, and position coordinates of the operation target. The View information includes an image of the target.

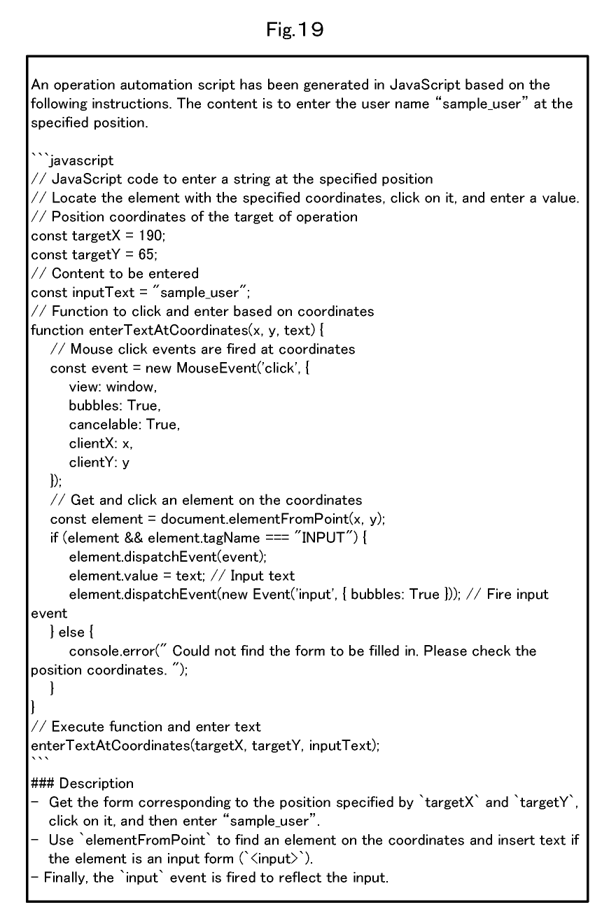

FIG. 19 shows an example of a response from a generative AI to the script creation section in the embodiment. It contains a script of the operation described in java script.

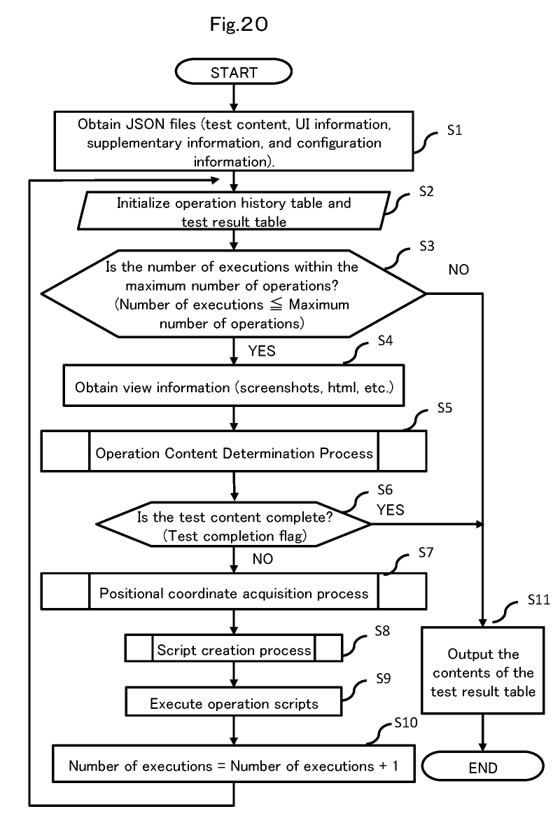

FIG. 20 is an example of a flowchart showing the overall system processing in the embodiment. Obtaining test contents, UI information, supplementary information, and configuration information in a JSON file (S1), and the operation history table and test result table are initialized (S2).

Refer to the operation history table and determine whether the number of executions is within the maximum number of operations (S3), if the number of operations is more than the maximum number of operations, the contents of the test result table are output from the output section (S11). If one operation is performed in one script execution, the number of times the script is executed is the number of operations.

If the number of operations is less than or equal to the maximum number of operations, View information such as screenshots is obtained (S4). Next, the operation decision section 11 uses the View information to ask the generative AI about the contents of the operation (S5), and then refers to the answer obtained from the generative AI to determine whether the test is complete (S6). If the test is complete, the output section outputs the contents of the test result table (S11).

If the test is not complete, the positional coordinate acquisition section 13 executes the positional coordinate acquisition process to obtain the positional coordinates of the operation target (S7). Using the positional coordinates obtained, script creation section 12 executes the script creation process to obtain a script (S8). The script obtained is executed in the browser by the script execution section 16 using an RPA (Robotic Process Automation) tool such as Selenium (S9), and 1 is added to the execution count (S10), returning to step S53. The RPA tool to be used is selected as appropriate for the type of script to be used.

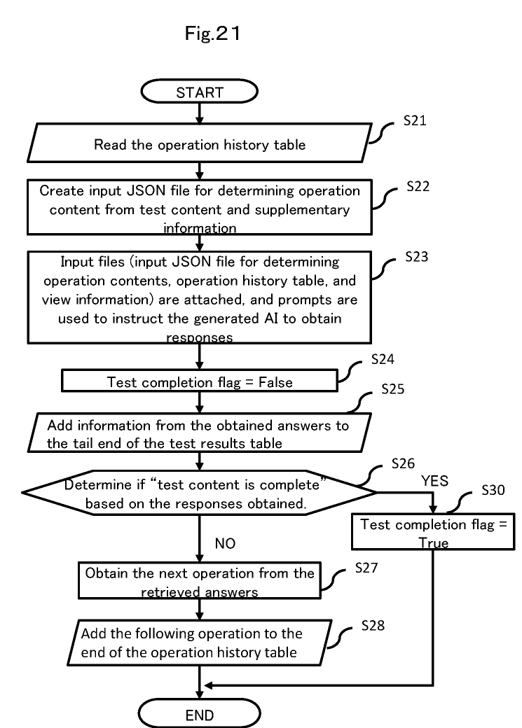

FIG. 21 is an example flowchart showing the processing of the operation decision section in the embodiment. First, the operation history table 21 is read (S21), and an input JSON file for the operation decision is created from the test contents and supplementary information (S22).

After attaching the input file including the input JSON file for determining the operation contents, the operation history file, and the View information, a prompt for generating the operation contents is sent to the generative AI, and the generated operation contents are obtained from the generative AI (S23).

Initialize the test complete flag as False (S24). Add the reasons for judgment, concerns, and supplementary information from the obtained responses to the tail end of the test result table (S25). The test content is judged to be complete based on the obtained generative AI responses, and if so, the test complete flag is set to True and the process ends (S30).

If the test is not complete, the next operation is obtained from the answers obtained from the generative AI (S27), the next operation is added to the tail end of the operation history table (S28), and the process ends.

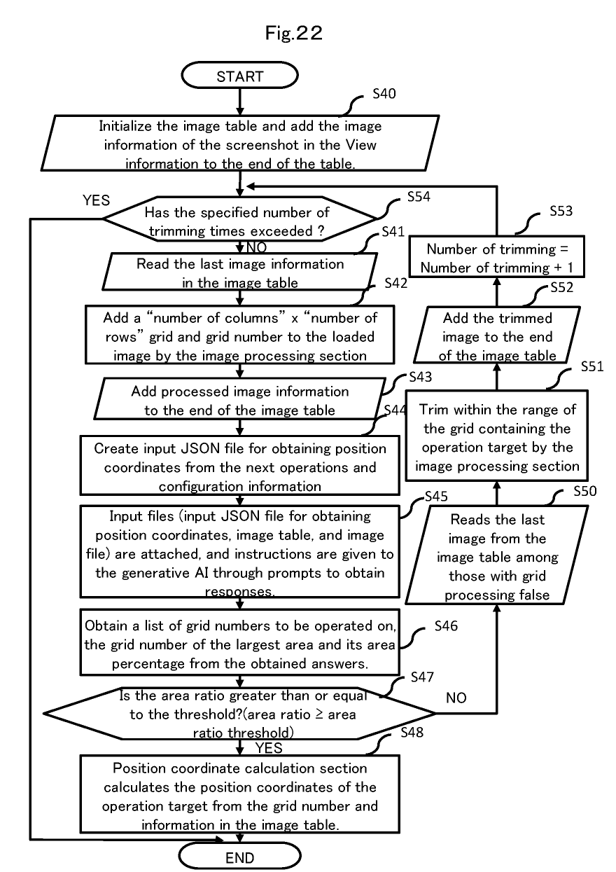

FIG. 22 shows an example flowchart of the processing of the positional coordinate acquisition section in the embodiment. Initialize the image table and add the image information of the screenshot of the View information to the tail end (S40).

If the number of trimming times exceeds the maximum number of trimming times specified in the configuration information of input file, an error is output and the process ends.

If the maximum number of trimming times has not been exceeded, the image information at the tail end of the image table is read (S41), and the image processing section 14 adds the "number of columns" × "number of rows" grid and grid number of the configuration information to the read image (S42). The processed image information is added to the tail end of the image table (S43).

Create an input JSON file for obtaining position coordinates from the next operation and configuration information (S44), and create a prompt requesting the grid number of the operation target, with an input file including the input JSON file for obtaining position coordinates, image table and image file attached, and send to the generative AI. The response including the grid number is received from the generative AI (S45).

Obtain a list of grid numbers of the operation target, the grid number of the largest area and its area percentage from the response received from the generative AI (S46).

If the area ratio is greater than or equal to a predetermined threshold (S47), the positional coordinates of the operation target are calculated from the grid number and image table information by using the positional coordinate calculation section 15 (S48). Specifically, the positional coordinates are calculated assuming that the center portion of the grid number of the largest area is the positional coordinates of the operation target.

If the grid number is less than the threshold value, the last image among those with false grid processing is read from the image table (S50). Next, the image processing section 14 trims the smallest rectangle that contains the grid of the grid number that includes the operation target as the trimming area (S51). Trimming reduces the grid size.

The trimmed image is added to the tail end of the image table (S52), 1 is added to the trimming number (S53), and the process returns to step S54.

In other words, if the occupancy ratio of the grid obtained is less than the predetermined occupancy ratio, it is possible to accurately obtain the position coordinates of the operation target by trimming to narrow the grid spacing of the above grid information until the occupancy ratio of the grid obtained exceeds the predetermined ratio.

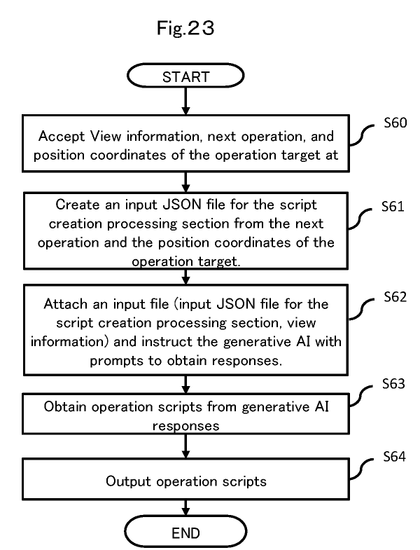

FIG. 23 is an example of a flowchart showing the processing of the script creation section in the embodiment. View information, next operation, and position coordinates of the operation target are received (S60), and an input JSON file for the script creation section is created from the next operation and position coordinates of the operation target (S61).

After attaching the input JSON file for the script creation section and the input file including View information, a prompt requesting the creation of a script is created and sent to the generative AI. The response is received from the generative AI (S62), and the operation script is obtained (S63). Output the received operation script (S64).

The present invention is not limited to the embodiments described above but includes various variations. For example, the above embodiments are described in detail to explain the invention in an easy-to-understand manner, and are not necessarily limited to those with all the described configurations.

It is also possible to replace some of the configurations of one embodiment with configurations of other embodiments, and it is also possible to add configurations of other embodiments to the configurations of one embodiment.

It is also possible to add, delete, and/or replace some of the configurations of each embodiment with other configurations. In addition, each of the above configurations, functions, processing sections, etc., may be realized in hardware by designing some or all of them, for example, in an integrated circuit.

### REFERENCE SIGNS LIST

1 Screen interface test system

2 CPU

3 Main storage

4 External storage

5 Input-output section

10 Control section

11 Operation decision section

12 Script creation section

13 Positional coordinate acquisition section

14 Image processing section

15 Positional coordinate calculation section

16 Script execution section

20 Image table

21 Operation history table

22 Test complete flag

23 Image file

24 Test result table

25 Input file

26 Prompt file

27 Answer file

1. A screen interface test system comprising,
an input part obtains image information of the screen to be tested, test contents and the number of operations,
an operation decision section creates a prompt that requests the creation of operation contents to be performed in the test based on the received image information and test contents, and receives the operation contents from a generative AI using the created prompt,
a script creation section creates a prompt requesting the creation of a script to perform the test based on the operation content received from the generative AI and the image information, and receives the script from the generative AI using the created prompt,
an output section that outputs test results when the number of times the script received from the generative AI has been executed reaches the number of operations.

2. The screen interface test system according to claim 1 comprising:
a positional coordinate acquisition section creates a prompt for the position of the operation target based on the image information and the operation content, and receives the positional coordinates of the operation target from the generative AI using the created prompt,
wherein the script creation section creates a prompt requesting the creation of a script to test based on the location coordinates.

3. The screen interface test system according to claim 1 comprising;
an operation history table stores operation details,
wherein the operation decision section adds the operation contents obtained from the generative AI to the operation history table, and when creating a prompt requesting the generation of operation contents, asks the generative AI whether the test is completed or not.

4. The screen interface test system according to claim 2,
wherein the positional coordinate acquisition section adds grid information to the image information to obtain the grid, and obtain the grid that occupies the widest area of the operation target,
when the obtained grid occupies less than the predetermined occupancy ratio, the grid size of the grid information is reduced until the obtained grid occupies more than the predetermined ratio, uses the coordinates of the obtained grid as the position coordinates of the target of operation.

5. The screen interface test method comprising:
an input section receiving the image information of the screen to be tested, the test contents, and the number of operations,
an operation decision section creating a prompt requesting the creation of the operation to be performed in the test based on the received image information and test contents, and receives the operation contents from the generative AI using the created prompt,
a script creation section creating a prompt requesting the creation of a script to perform the test based on the operation content received from the generative AI and the image information, and receives the script from the generative AI using the created prompt,
an output section outputting test results when the number of times the script received from the generative AI has been executed reaches the number of operations.
